(19) United States
(12) Patent Application Publication
(10) Pub. No.: US 2008/0138113 A1
(43) Pub. Date: Jun. 12, 2008

(54) Disturbance Feature to Promote Image Process Member Drive Train Engagement

(76) Inventors: Niko Jay Murrell, Lexington, KY (US); Darren Wayne Tosh, Lexington, KY (US); Douglas H. Eskew, Versailles, KY (US)

Correspondence Address: John J. McArdle, Jr.;Lexmark International, Inc., Intellectual Property Department, 740 West New Circle Road, Lexington, KY, 40550, US

(21) Appl. No.: 11/609,054

(22) Filed: Dec. 11, 2006

(51) Int. Cl. B41J 2/385

(52) U.S. Cl. 399/167

(57) ABSTRACT

Discrete disturbance features are included in a process member drive train coupling mechanism to prevent the mechanism from remaining in a disengaged position. The mechanism may include a rotatable drive receiver operative to rotate an electrophotographic imaging process member and a coupler including a driver. The driver and drive receiver may include respective mating drive features to transmit rotary drive forces to the process member. The coupling mechanism includes one or more disturbance features located at discrete radial positions relative to a rotation axis of the coupler at an interface between the driver and the drive receiver. As the coupler rotates, the disturbance feature disrupts the position of the coupler to align the driver and drive receiver and move the coupler towards an engaged position in which the first and second drive features are engaged.

### BACKGROUND

Process cartridges in image forming devices are typically consumable items that may be removed and/or replaced by the end user. The process cartridges often include rotating process members (e.g., photoconductive drums, developer rollers, toner paddles) that are driven by motors that are located elsewhere within the image forming device. Since the process cartridge is removable, the drive train that couples the motors and the rotating process members may include gears and/or couplers that disengage upon removal of the process cartridge. The gears and/or couplers are also configured to re-engage the process cartridge upon insertion of the process cartridge.

In certain instances, the respective gears/couplers on the process cartridge may not engage the mating gears/couplers in the image forming device upon insertion of the process cartridge. This faulty engagement may be caused by several factors, including tolerance stack up, product variation, manufacturing defects, and the like. Additional problems arise in that the point of engagement of the drive train is not always readily visible or accessible to correct the engagement. As a consequence, the rotating process members may not be driven in the desired manner, rendering the process cartridge ineffective in image formation.

### SUMMARY

Embodiments of the present invention are directed to discrete disturbance features in a process member drive train coupling mechanism to prevent the mechanism from remaining in a disengaged position. The mechanism may include a rotatable drive receiver operative to rotate an electrophotographic imaging process member and a coupler including a driver The driver and drive receiver may include respective mating drive features to transmit rotary drive forces to the process member. The coupling mechanism includes one or more disturbance features located at discrete radial positions relative to a rotation axis of the coupler at an interface between the driver and the drive receiver. The disturbance feature may be formed on the driver or the drive receiver. The disturbance features may be formed as notches, protrusions, or other features that disturb the position of the coupler. As the coupler rotates, the disturbance feature disrupts the position of the coupler to align the driver and drive receiver and move the coupler towards an engaged position in which the first and second drive features are engaged.

The coupler may be moveable along a rotation axis from a disengaged position in which the driver an drive receiver are not coupled and an engaged position in which the driver and drive receiver are coupled to rotate the process member. The disturbance feature engaged the drive receiver to disrupt the position of the coupling in a direction transverse to the rotation axis to move the coupling from an intermediate equilibrium position between the engaged and disengaged positions and towards the engaged position under the influence of a biasing force.

### BRIEF DESCRIPTION OF THE DRAWINGS

FIG. 1 is a schematic diagram of a representative image forming apparatus having a plurality of pairs of detachable developer units and photoconductor units;

FIG. 2 is a schematic diagram of a representative image forming apparatus having an openable and closable subunit;

FIG. 3 is a perspective view of a pivoting coupling retraction plate assembly;

FIG. 4A is a top view of the pivoting coupling retraction plate assembly in an engaged position;

FIG. 4B is a top view of the pivoting coupling retraction plate assembly in a retracted position;

FIG. 5 is a side view of an exemplary process member drive train coupling according to one embodiment;

FIG. 6 is an exploded perspective view of an exemplary process member drive train coupling according to one embodiment;

FIG. 7 is a perspective view of an improperly engaged process member drive train coupling according to one embodiment;

FIG. 8 is a side view of an improperly engaged process member drive train coupling according to one embodiment;

FIG. 9 is a graphical representation of multiple equilibrium positions for a process member drive train coupling according to one embodiment;

FIG. 10 is a perspective view of an output of a process member drive train coupling including a plurality of disturbing features according to one embodiment;

FIG. 11 is a side view of an output of a process member drive train coupling including a disturbing feature according to one embodiment;

FIG. 12 is a side view of an output of a process member drive train coupling including a plurality of disturbing features according to one embodiment;

FIG. 13 is a side view of an output of a process member drive train coupling including a plurality of disturbing features according to one embodiment;

FIG. 14 is a perspective view of a process member drive train coupling including a plurality of disturbing features according to one embodiment; and

FIG. 15 is a perspective view of a properly engaged process member drive train coupling according to one embodiment.

### DETAILED DESCRIPTION

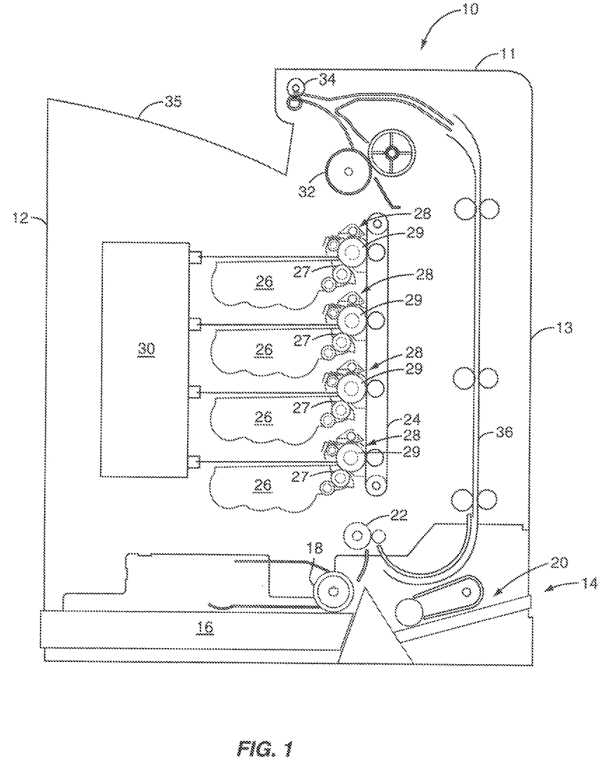

The various embodiments disclosed herein are directed to a technique for promoting the proper engagement of a process member drive train. Embodiments disclosed herein include disturbance features that prevent a drive train coupling from remaining in a disengaged position. The embodiments may be implemented in an image forming device to improve the likelihood of properly engaging rotating process members in a removable process cartridge. To that end, FIG. 1 depicts a representative image forming apparatus, indicated generally the numeral 10. The image forming apparatus 10 comprises a body 12 with a top portion 11, subunit 13 and a media tray 14. The media tray 14 includes a main media sheet stack 16 with a sheet pick mechanism 18, and a manual input 20. The media tray 14 is preferably removable for refilling, and in the embodiment shown, is located on a lower section of the device 10. One example of an image forming device including these and other features described herein is the Lexmark C52X or the C53X series of color laser printers available from Lexmark International.

Within the image forming apparatus body 12 and/or in the subunit 13, the image forming apparatus 10 includes registration rollers 22, a media sheet transfer belt 24, one or more removable developer units 26, a corresponding number of removable photoconductor units 28, an imaging device 30, a fuser 32, reversible exit rollers 34, and a duplex media sheet path 36, as well as various rollers, actuators, sensors, optics, and electronic (not shown) as are conventionally known in the image forming apparatus arts, and which are not further explicated herein.

The internal components of the developer units 26 and photoconductor units 28 are briefly described (these components are not all explicitly depicted in the drawings). Each developer unit 26 is a removable cartridge that includes a reservoir holding a supply of toner, paddles to agitate and move the toner, a toner adder roll for supplying toner to a developer roll 27, a developer roll 27 for applying toner to develop a latent image on a (separate) photoconductive drum 29, and a doctor blade to regulate the amount of toner on the developer roll 27. Each photoconductor unit 28 is a separate removable cartridge that includes a photoconductive (PC) drum 29. The PC drum 29 may comprise, for example, an aluminum hollow-core drum coated with one or more layers of light-sensitive organic photoconductive materials. The photoconductor unit 28 also includes a charge roll for applying a uniform electrical charge to the surface of the PC drum 29, a cleaner blade for removing residual toner from the PC drum 29, and an auger to move waste toner out of the photoconductor unit 28 into a waste toner container (not shown).

Each developer unit 26 mates with a corresponding photoconductor unit 28, with the developer roll 27 of the developer unit 26 developing a latent image on the surface of the PC drum 29 of the photoconductor unit 28 by supplying toner to the PC drum 29. In a typical color printer, four colors of toner—cyan, yellow, magenta, and black—are applied successively (and not necessarily in that order) to a print media sheet to create a color image. Correspondingly, FIG. 1 depicts four pairs of developer units 26 and photoconductor units 28. Each of the developer units 26 and photoconductor units 28 include rollers, drums, augers, paddles, and/or similar generally cylindrical elements that are rotationally driven from a single rotational drive input by a drive train, such as a network of gears within or appended to the respective cartridge housing.

The operation of the image forming apparatus 10 is conventionally known. Upon command from control electronics, a single media sheet is “picked, ” or selected, from either the primary media stack 16 or the manual input 20. Alternatively, a media sheet may travel through the duplex path 36 for a two-sided print operation. Regardless of its source, the media sheet is presented at the nip of a registration roller 22, which aligns the sheet and precisely controls its further movement into the print path.

The media sheet passes the registration roller 22 and electrostatically adheres to transport belt 24, which carries the media sheet successively past the photoconductor units 28. At each photoconductor unit 28, a latent image is formed by the imaging device 30 and optically projected onto the PC drum 29. The latent image is developed by applying toner to the PC drum 29 from the developer roll 27 of the corresponding developer unit 26. The toner is subsequently deposited on the media sheet as it is conveyed past the photoconductor unit 28 by the transport belt 24.

The toner is thermally fused to the media sheet by the fuser 32, and the sheet then passes through reversible exit rollers 34, to land facedown in the output stack 35 formed on the exterior of the image forming apparatus body 12. Alternatively, the exit rollers 34 may reverse motion after the trailing edge of the media sheet has passed the entrance to the duplex path 36, directing the media sheet through the duplex path 36 for the printing of another image on the back side thereof.

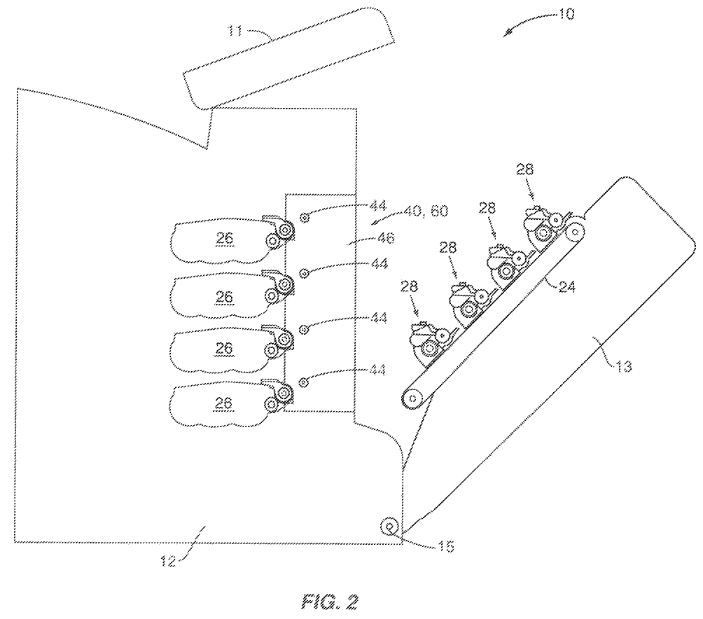

FIG. 2 depicts an image forming apparatus 10 wherein a subunit 14 is separated from the main housing 12 by pivoting about a hinge point 15. At least the media sheet transport belt 24 and the photoconductor units 28 are mounted to the subunit 13. To allow the photoconductor units 28 to clear the housing 12 when the subunit 13 is opened, the photoconductor units 28 must first be decoupled from the drive mechanism couplings 44 within the housing 12 that supply rotary power to the photoconductor units 28. Additionally, to remove or insert a developer unit 26 from or into the housing 12, at least the developer unit 26 of interest must be decoupled from the drive mechanism coupling (not shown) that supplies rotary power to it. Furthermore, since the developer units 26 are inserted and removed from the housing 12 in a direction at right angles to the axes of the rollers within the cartridges, the drive mechanism couplings must be decoupled to provide mechanical clearance for the removal or insertion of the developer unit 26 cartridges.

In one implementation, all of the drive mechanism couplings to all developer units 26 and photoconductor units 28 may be decoupled, or retracted, simultaneously, allowing any cartridge to be removed and/or replaced without the necessity of individually retracting its drive mechanism coupling. In the illustrated embodiment, the drive mechanism couplings are retracted automatically from the cartridges whenever the subunit 13 is opened to allow access to the cartridges, without requiring conscious action on the part of the operator. According to various embodiments of the present invention, all of the drive couplers supplying rotary power to the developer units 26 and the photoconductor units 28 are retracted simultaneously, by actuation of a retraction plate 46 within a coupling retraction mechanism 40, 60, as described herein.

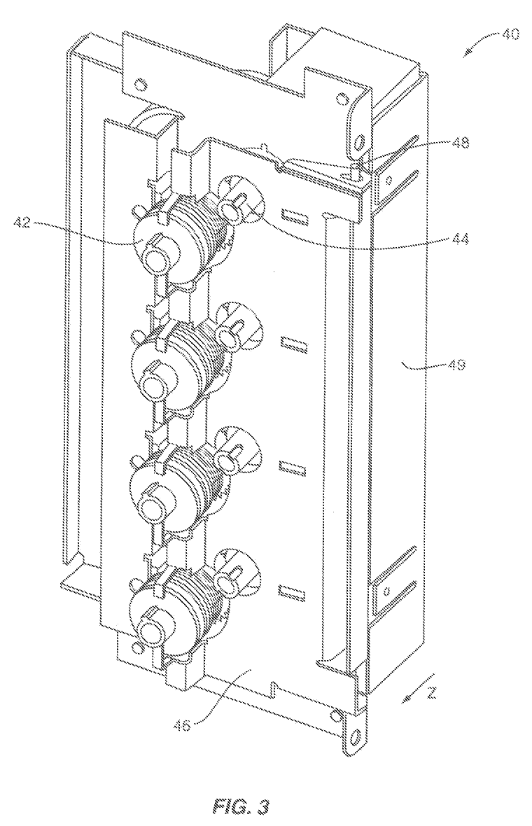

In particular, a pivoting coupling retraction mechanism according to one embodiment of the present invention is depicted in FIG. 3, indicated generally by the numeral 40. The pivoting coupling retraction mechanism 40 comprises a gearbox frame 49 housing various drive components such as motors, gears, and the like, and a pivoting retraction plate 46. Mounted to the gearbox frame 49, and axially retained by the pivoting retraction plate 46, is a plurality of developer unit couplers 42, which mate with and provide rotational power to a corresponding plurality of developer units 26. In this embodiment, the developer unit couplers 42 comprise Oldham couplings, which are capable of transferring rotary power between two parallel, but not necessarily radially aligned, shafts. Additionally mounted to gearbox frame 49, and axially retained by the pivoting retraction plate 46, is a plurality of photoconductor unit couplers 44, each of which couples with and provides rotary power to a corresponding photoconductor unit 28.

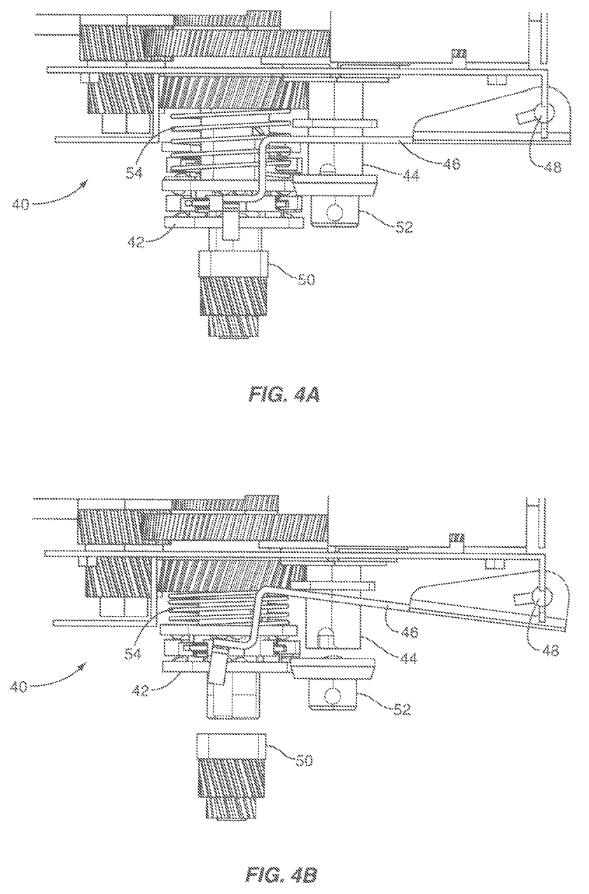

The developer unit couplers 42 and photoconductor unit couplers 44 are biased in the positive z-direction (out of the page as depicted in FIG. 3), such as by springs 54 (see FIGS. 4A, 4B). The couplers 42, 44 mate with their respective input members on the removable cartridges when the pivoting retraction plate 46 is in an engaged position, and are constrained in the positive z-direction by the pivoting retraction plate 46 when it is in a retracted position. According to the present invention, all developer unit couplers 42 and photoconductor unit couplers 44 (four of each in the embodiment depicted in FIG. 3) are simultaneously retracted in the negative z-direction (i.e., in an axial direction of the coupler shafts) as the pivoting retraction plate 46 moves from an engaged to a retracted position.

In the embodiment depicted in FIG. 3, the pivoting retraction plate 46 moves from an engaged to a retracted position by pivoting about a pivot rod 48. For instance, the pivoting retraction plate 46 pivots through an angle between about 5° and 10°. FIGS. 4A and 4B depict the coupling retraction operation of the pivoting coupling retraction mechanism 40. In FIG. 4A, the mechanism 40 is in an engaged position, with the developer unit coupler 42 coupled to a developer unit drive receiver 50, which is affixed to the developer unit 26 (not shown). In this engaged position, the biasing spring 54 urges the developer unit coupler 42 into engagement with the developer unit drive receiver 50. Additionally, the photoconductor unit coupler 44 is coupled to a photoconductor unit drive receiver 52, attached to a photoconductor unit 28 (not shown). Note that all (e.g., four) pairs of developer unit couplers 42 and photoconductor unit couplers 44 are simultaneously engaged.

FIG. 4B depicts the pivoting coupling retraction mechanism 40 in a retracted position, wherein the pivoting retraction plate 46 has rotated about the pivot pin 48. The pivoting retraction plate 46 retracts both the developer unit coupler 42 and the photoconductor unit coupler 44 laterally, in an axial direction, thus disengaging the couplers 42, 44 from the developer unit and photoconductor unit drive receivers 50, 52, respectively. The biasing spring 54 is compressed in this disengaged position. With the couplers 42, 44 thus retracted, the subunit 13 holding the photoconductor units 28 may be opened (to facilitate the removal or installation of a photoconductor units 28), and the developer units 26 may be freely removed from, or inserted into, the housing 12 of the image forming apparatus 10.

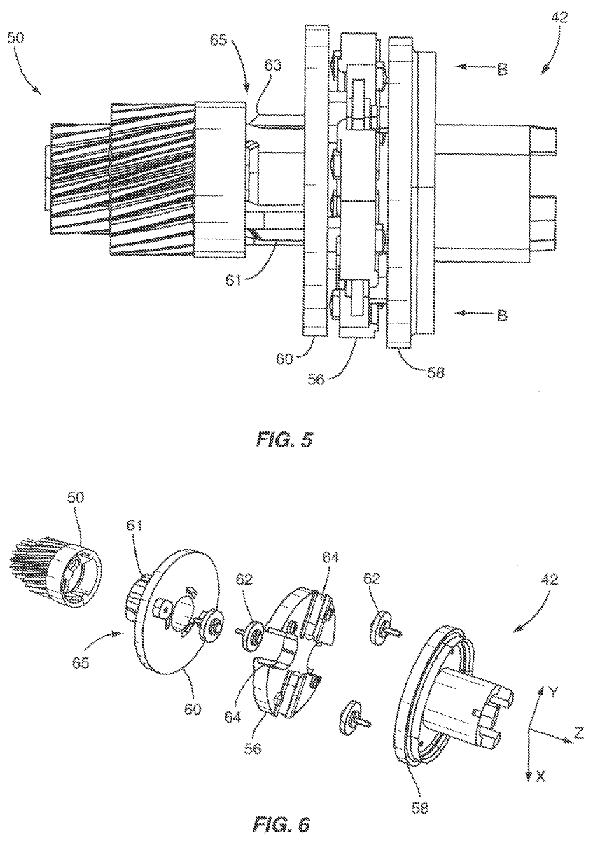

The developer unit couplers 42 comprise Oldham couplings to improve the likelihood of properly engaging the developer unit drive receivers 50. FIG. 5 depicts a detail side view of a developer unit coupler 42 at a point of initial engagement with a developer unit drive receiver 50. FIG. 6 depicts an exploded view of the same developer unit coupler 42 and the drive receiver 50. The developer unit coupler includes a floating intermediate member 56 that is loosely coupled between an input member 58 and an output member 60. The developer unit coupler 42 includes a plurality of rollers 62 that are secured to the input 58 or output 60 members. The rollers 62 roll within slots 64 in the intermediate member. With this configuration, the output member 60 is free to float in the X-Y plane to account for radial misalignment between the developer unit coupler 42 and drive receiver 50. Splines 61 on the output member 60 mate with similar features on the inside of the drive receiver 50. The biasing spring 54 (see FIGS. 4A, 4B) urges the developer unit coupler 42 in the negative Z direction and in the direction indicated by arrows B into engagement with the developer unit drive receiver 50. The leading end 65 of the output member 60 further includes chamfers 63 to further promote engagement of the output member 60 into the drive receiver 50.

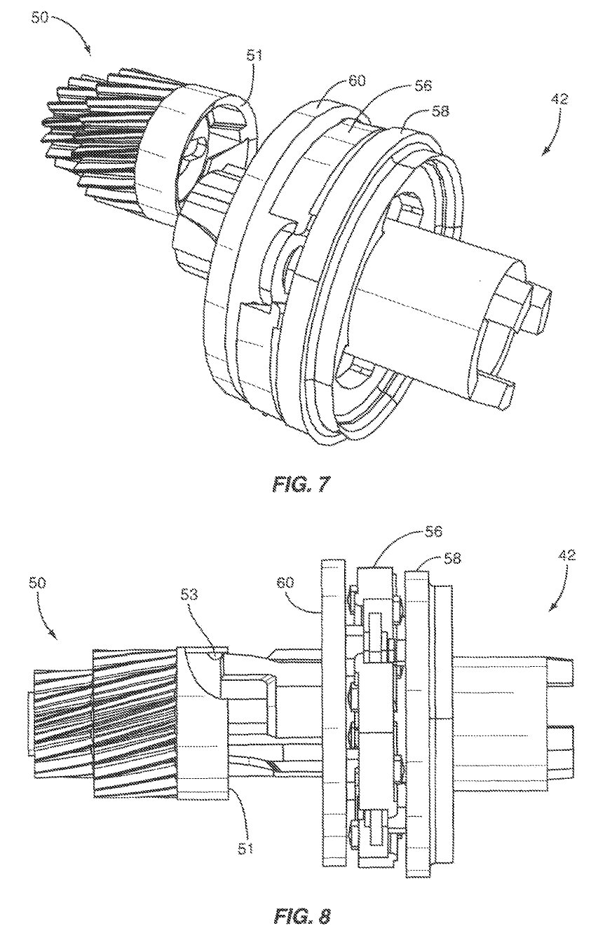

Regardless of the biasing force Band the chamfers 63, reliable engagement between the output member 60 and the drive receiver 50 may not be guaranteed. FIGS. 7 and 8 depict possible scenarios where the output member 60 and the drive receiver 50 are not properly engaged. In FIG. 7, the developer unit coupler 42 is misaligned a sufficient amount that the output member 60 rests on the outer lip 51 of the drive receiver 50. In FIG. 8, the misalignment between the developer unit coupler 42 and the driver receiver 50 is less severe. However, an internal defect 53 within the drive receiver 53 prohibits further engagement of the output member 60 into the drive receiver 50. Some examples of defects 53 that may cause this situation include machine burrs, casting flash, parting lines, wear defects, and the like. The defect 53 may be minimal, but since the developer unit coupler 42 is urged into engagement with the defect 53, the output member 60 becomes locked against the defect 53. Further, the defect 53 need not be isolated to the drive receiver 50. Defects 53 located on the output member 60 may cause a similar lack of engagement.

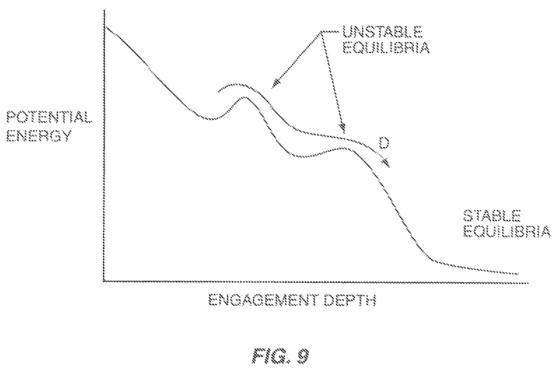

These engagement problems are depicted graphically in FIG. 9. In essence, the output member 60 has come to rest at a point of unstable equilibrium. FIG. 9 shows two points of unstable equilibria that may be caused by the misalignment shown in FIG. 7 or by the defect 53 shown in FIG. 8. In either case, the biasing spring 54 includes some amount of potential energy that would tend to cause the output member 60 to further engage the drive receiver 50 but for the engagement defects illustrated in FIGS. 7 and 8. However, in the absence of some disturbance to cause the output member 60 to move in the direction of arrow D from the unstable equilibrium to the stable equilibrium, the developer unit coupler 42 may remain engaged to the drive receiver 50 at the unstable equilibrium.

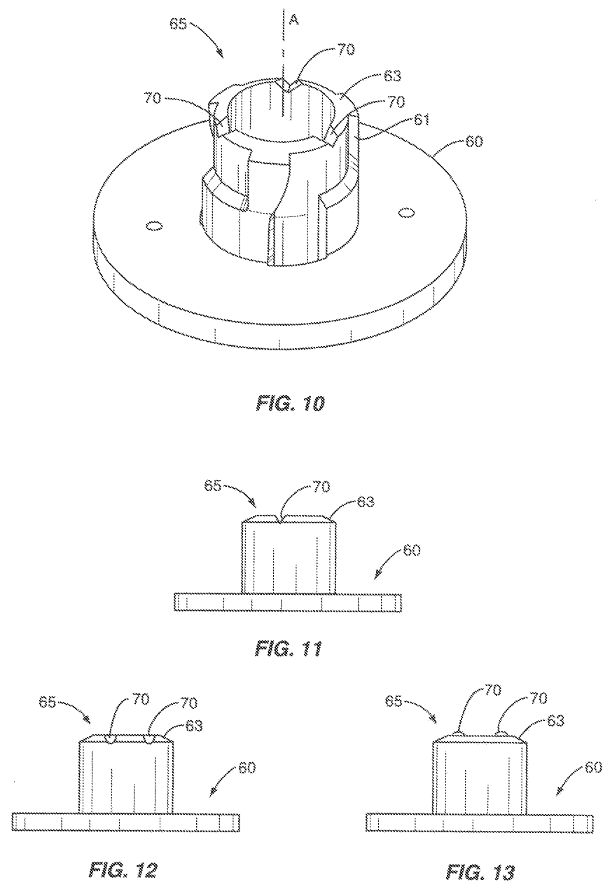

To account for these possible engagement problems, one or more disturbance features 70 are incorporated into the output member 60 as shown in FIG. 7. The disturbance features 70 are incorporated into the leading end 65 of the output member 60. In the illustrated embodiment, the disturbance features 70 include notches that extend through the chamfered end 63 of the output member. The disturbance features 70 may be implemented with or without the aid of a chamfer 63 at the leading end 65 of the output member 60. The disturbance features 70 are discrete and located at a particular radial position on the output member 60. Thus, the disturbance features 70 may contact the drive receiver 50 once per revolution of the output member 60 to disrupt the position of the output member 60 and promote engagement with the drive receiver 50. The exemplary output member 60 includes three disturbance features that are spaced apart approximately 120 degrees about the rotation axis A of the output member 60. In other embodiments, multiple disturbance features 70 may be spaced apart an unequal distance. Further, while FIG. 10 depicts three disturbance members 70, a greater or lesser number of disturbance features 70 may be incorporated into the output member 60.

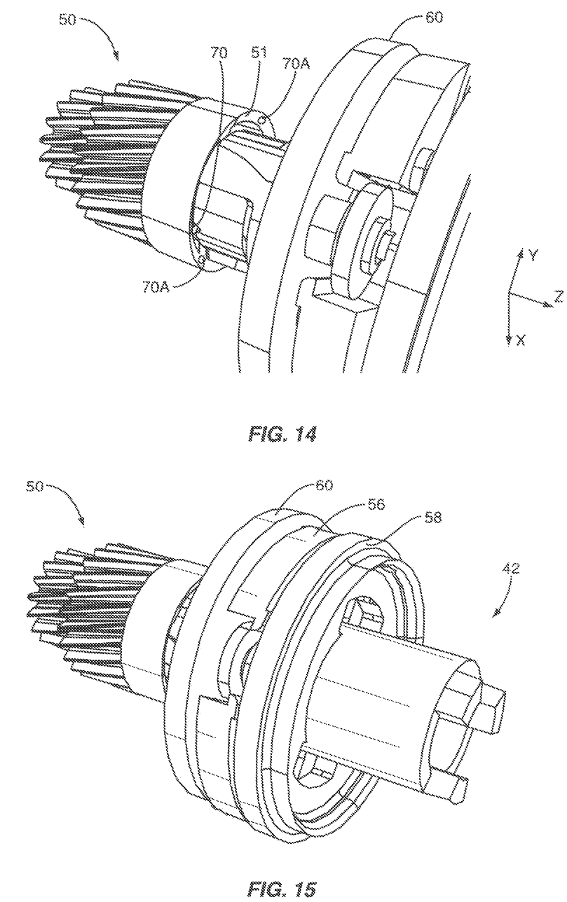

Furthermore, as FIG. 11 shows, the output member 60 may include a single disturbance feature 70. Other types and shapes of disturbance features 70 may be used. For example, FIG. 12 depicts a plurality of disturbance features 70 implemented as U-shaped notches in contrast with the V-shaped notches in FIGS. 10 and 11. Other notch shapes may be used, including for example, diamond, pyramid, circular, elliptical, round, square, trapezoidal, or other shapes that would occur to one skilled in the art. In addition, the disturbance features 70 need not be limited to notches. In one embodiment shown in FIG. 13, the disturbance features 70 comprise protrusions extending outward from the leading end 65 of the output member 60. The disturbance features 70 may further include teeth, knurls, slots, grooves, undulations, or other features conceivable by those skilled in the art. Also, the disturbance features 70 need not be limited to the output member 60. FIG. 14 depicts an engagement between exemplary output member 60 and drive receiver 50, where each includes respective disturbance features 70, 70A. The disturbance features 70A on the drive receiver 50 may be appropriate when the drive receiver 50 rotates itself or rotates at a mismatched speed from the output member 60. Thus, the disturbance features 70A on the drive receiver 50 are not necessary in all embodiments and may not be preferable in some embodiments.

Upon rotation of the output member 60 from an associated drive motor (not shown) the disturbance features 70, 70A on one or both of the output member 60 and drive receiver 50 may disturb the relative position of the output member 60 in the X-Y plane. The amount of disturbance is sufficient to cause the output member 60 to move into alignment with the drive receiver 50. Consequently, the output member 60 moves from the unstable equilibrium point (FIG. 9) towards the stable equilibrium point where the output member 60 becomes positively engaged with the drive receiver 50 as shown in FIG. 15.

The present invention may be carried out in other specific ways than those herein set forth without departing from the scope and essential characteristics of the invention. For example, embodiments described above have contemplated an Oldham coupling implemented at the developer unit coupler 42 to engage a corresponding developer unit drive receiver 50. Those skilled in the art should appreciate that Oldham couplings may be used to engage different process members, including but not limited to a photoconductive member, a toner adder roller, and toner agitators. Thus, the disturbance features described herein may be implemented on Oldham couplings used to drive other process members besides a developer roller. Further, the disturbance features need not be limited to use with Oldham couplings. The disturbance features may product significant opportunity for engagement of other types of drive train couplings that permit limited or significant amounts of radial play. Furthermore, the disturbance features are certainly applicable in other types of image forming devices besides the examples provided herein. The present embodiments are, therefore, to be considered in all respects as illustrative and not restrictive, and all changes coming within the meaning and equivalency range of the appended claims are intended to be embraced therein.

What is claimed is:

1. A coupling mechanism for rotatably engaging an electrophotographic imaging process member comprising:
a rotatable drive receiver operative to rotate the electrophotographic imaging process member, the drive receiver including first drive features; and
a rotary coupler including a driver with second drive features that engage the first drive features, the driver including a disturbance feature located at a discrete radial position relative to a rotation axis of the coupler and at a leading end of the driver facing towards the drive receiver, the disturbance feature disrupting a position of the coupler in a direction transverse to the rotation axis upon contacting the drive receiver to move the coupling towards an engaged position in which the first and second drive features are engaged.

2. The coupling mechanism of claim 1 wherein the drive receiver and the driver are substantially cylindrical.

3. The coupling mechanism of claim 1 wherein the disturbance feature is formed as a notch at the leading end of the driver.

4. The coupling mechanism of claim 1 wherein the disturbance feature is formed as a protrusion at the leading end of the driver.

5. The coupling mechanism of claim 1 wherein the process member is a photoconductive drum.

6. The coupling mechanism of claim 1 wherein the process member is a developer roller.

7. The coupling mechanism of claim 1 wherein the rotary coupler is an Oldham coupling.

8. An electrophotographic image forming device comprising:
an electrophotographic imaging process member including an input drive receiver to rotate the process member;
as associated drive train to rotate the process member;
a coupling to rotatably connect the drive train to the input drive receiver, the coupling urged towards the drive receiver by a biasing force and including a disturbance feature at a leading end of the coupling facing the drive receiver, the coupling axially moveable along a rotation axis from a disengaged position in which the drive train and drive receiver are not coupled and an engaged position in which the drive train and drive receiver are coupled to rotate the process member.
the disturbance feature engaging the drive receiver and operative to disrupt the position of the coupling in a direction transverse to the rotation axis to move the coupling from an intermediate equilibrium position between the engaged and disengaged positions and towards the engaged position under the influence of the biasing force.

9. The image forming device of claim 8 wherein the process member is a photoconductive drum.

10. The image forming device of claim 8 wherein the process member is a developer roller.

11. The image forming device of claim 8 wherein the coupling comprises an Oldham coupler.

12. The image forming device of claim 8 wherein the disturbance feature is formed as a protrusion at the leading end of the coupling.

13. The image forming device of claim 8 wherein the disturbance feature is formed as a notch at the leading end of the coupling.

14. A method of engaging a drive train coupler with an electrophotographic imaging process member to rotate the process member, the method comprising:
causing the drive train coupler to move in an axial direction into contact with a drive receiver operative to rotate the electrophotographic imaging process member, each of the drive train coupler and the drive receiver including respective mating drive features to transmit rotary drive forces from the drive train coupler to the process member;
urging the drive train coupler into a unstable equilibrium position in which the drive train coupler contacts the drive receiver but in which the mating drive features are not engaged;
disrupting a position of the drive train coupler at discrete rotational angles of the drive train coupler relative to the axial direction; and
further urging the drive train coupler into a stable equilibrium position in which the mating drive features are engaged.

15. The method of claim 14 wherein disrupting the position of the drive train coupler further comprises moving the drive train coupler in a direction transverse to the axial direction.

16. The method of claim 14 wherein a spring urges the drive train coupler towards the drive receiver.

17. The method of claim 14 wherein the step of disrupting a position of the drive train coupler at discrete rotational angles comprises rotating the drive train coupler so that a disturbance feature at a leading end of the drive train coupler engages the drive receiver.

18. The method of claim 17 wherein the disturbance feature is formed as a notch.

19. The method of claim 17 wherein the disturbance feature is formed as a protrusion.

20. The method of claim 14 wherein the drive train coupler is an Oldham coupling.
